(19) United States
(12) Patent Application Publication
(10) Pub. No.: US 2024/0302633 A1
(43) Pub. Date: Sep. 12, 2024

(54) LENS MODULE AND TERMINAL EQUIPMENT HAVING THE SAME

(71) Applicant: Rayprus Technology (Foshan) Co., Ltd., Foshan (CN)

(72) Inventor: YUAN-HSU CHOU, NewTaipei (TW)

(21) Appl. No.: 18/230,204

(22) Filed: Aug. 4, 2023

(30) Foreign Application Priority Data
Mar. 9, 2023 (CN) 202310227171.7

(51) Int. Cl. G02B 13/06; G02B 13/00; G02B 27/00

(52) U.S. Cl. CPC G02B 13/06; G02B 13/0045; G02B 27/0025

(57) ABSTRACT

A lens module includes a plurality of lenses arranged in sequence from an object side to an image side along an optical axis. At least one lens of the plurality of lenses is a freeform lens. An object-side surface and/or an image-side surface of the freeform lens is a freeform surface. An X-axis and a Y-axis are defined as two central axes perpendicular to each other on an image surface of the lens module. the freeform surface is described by the following sag equation:

$$Z = \frac{{C}_{x} {x}^{2} + {C}_{y} {y}^{2}}{\sqrt{1 - ( 1 + {k}_{x} ) {C}_{x}^{2} {x}^{2} - ( 1 + {k}_{y} ) {C}_{y}^{2} {y}^{2}}} + {\sum }_{i = 1}^{16} {α}_{i} {x}_{i} + {\sum }_{i = 1}^{16} {β}_{i} {y}_{i} + {\sum }_{i = 1}^{N} {A}_{i} {Z}_{i} ( ρ , φ )$$

Wherein,

$${C}_{x} = \frac{1}{Rx} , {C}_{y} = \frac{1}{Ry} ,$$

z is a sag of an optical surface; Rₓ and R_{y} are radius of curvature values in the x and y directions respectively; kₓ and k_{y} are conic coefficients; αᵢ, βᵢ are polynomial coefficients; Aᵢ is a polynomial coefficient, ρ is a radial coordinate, φ is an angular coordinate, and N is a number of terms. A terminal device also provided.

### FIELD

The subject matter herein generally relates to optical imaging, particularly to a lens module and a terminal equipment having the lens module.

### BACKGROUND

Ultra-wide-angle lenses have a wider field of view (FOV) and are widely used in image recognition technology. However, with the increase of the ultra-wide-angle lens, optical distortion may occur. Thus, the images captured by such lens needed to be processed by a software to correct the optical distortion.

However, the existing software cannot provide enough computing power to correct dynamic videos with optical distortion.

### BRIEF DESCRIPTION OF THE DRAWINGS

Implementations of the present technology will now be described, by way of example only, with reference to the attached FIG.s, wherein:

FIG. 1 is a diagrammatic view of a terminal device according to an embodiment of the present disclosure.

FIG. 2 is a diagrammatic view of a lens module according to an embodiment of the present disclosure.

FIG. 3 is a cross-sectional view of the lens module of FIG. 2.

FIG. 4 is a diagrammatic view showing a projection of a freeform lens of FIG. 2 in directions of an X and an Y axis.

FIG. 5 shows an astigmatic field curve and a distortion curve of the lens module of FIG. 2.

FIG. 6 shows an astigmatic field curve and a distortion curve of a lens module according to a comparative example of the present disclosure.

### DETAILED DESCRIPTION

It will be appreciated that for simplicity and clarity of illustration, where appropriate, reference numerals have been repeated among the different FIG.s to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

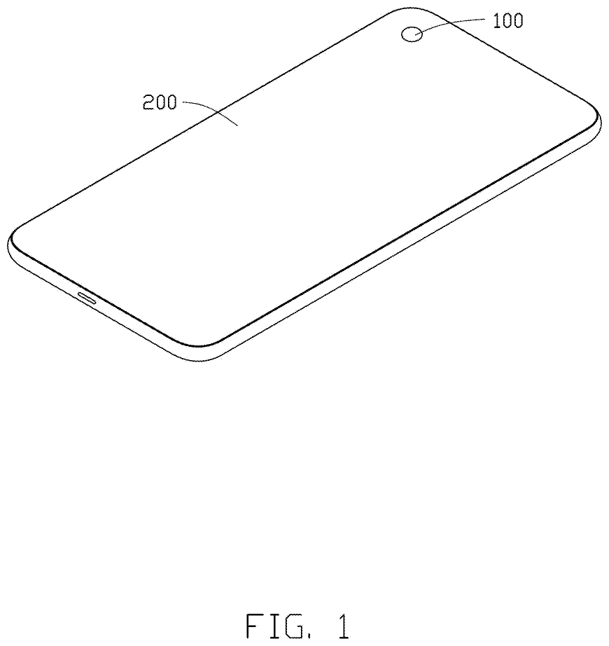

Referring to FIG. 1, an embodiment of the present disclosure provides a lens module 100, which can be applied in a terminal device 200. The terminal device 200 can be a mobile phone, IPAD, and other portable terminals. The lens module 100 can be an ultra-wide-angle lens group. The lens module 100 is fixed inside a housing (not labeled) of the terminal device 200, and can be the rear lens or the front lens of the terminal device 200. The lens module 100 can also be a telescopic lens that can protrude from the housing of the terminal device 200.

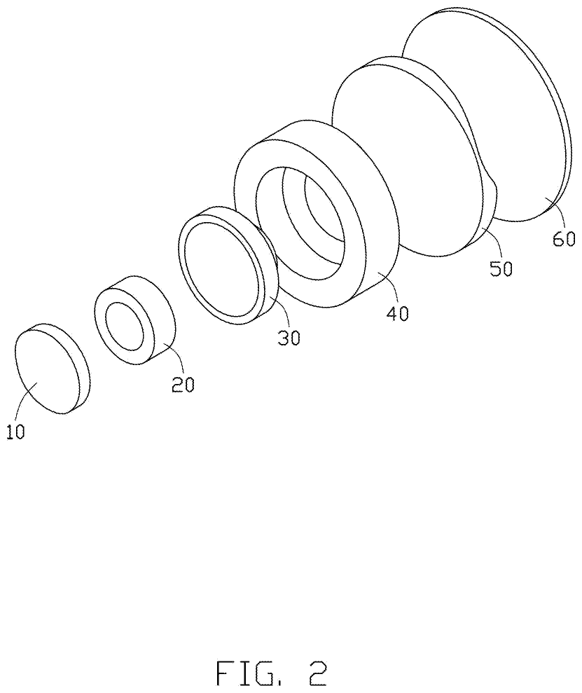

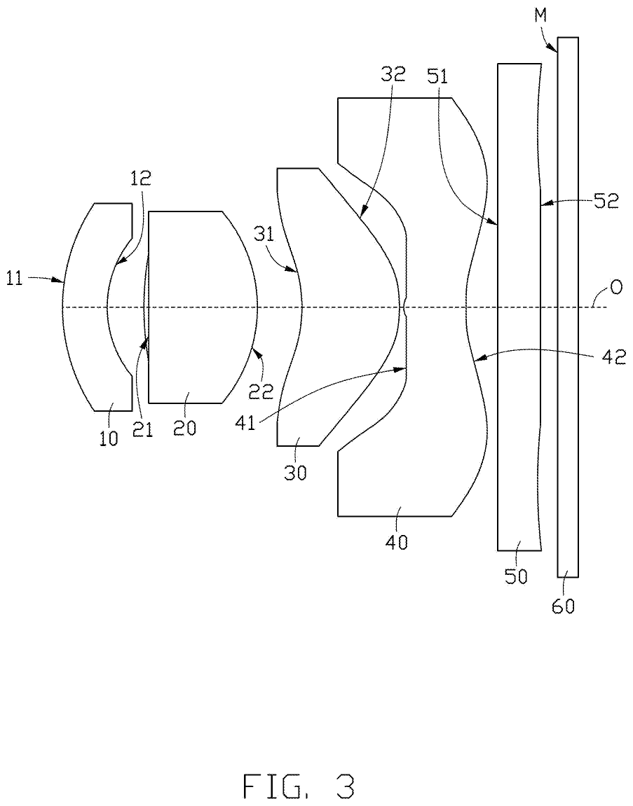

Referring to FIGS. 2 and 3, in this embodiment, the lens module 100 includes multiple lenses. Along an optical axis O of the lens module 100 from an object side to an image side, the lens module 100 sequentially includes a first lens 10, a second lens 20, a third lens 30, a fourth lens 40, a fifth lens 50, and a image element 60. In other embodiments, the lens module 100 may also include more than five lenses or less than five lenses. The image element 60 is a planar photosensitive chip. A surface of the image element 60 facing the fifth lens 50 is defined as an image surface M.

Referring to FIGS. 2 and 3, in this embodiment, the fifth lens 50 includes an image-side surface 52 facing the image side and an object-side surface 51 facing the object side. The image-side surface 52 of the fifth lens 50 is a freeform surface (that is, the fifth lens 50 is a freeform lens). In another embodiment, the image-side surface 52 and the object-side surface 51 of the fifth lens 50 are both freeform surfaces. In other embodiments, any one or two of the image-side surface or object-side surface of each of the first lens 10, the second lens 20, the third lens 30, and the fourth lens 40 may be freeform surfaces.

X-axis and Y-axis are defined as two axes perpendicular to each other. Each of the X-axis and Y-axis is parallel to the image surface M of the lens module 100. The freeform surface is described by the following sag equation:

$$Z = \frac{{C}_{x} {x}^{2} + {C}_{y} {y}^{2}}{\sqrt{1 - ( 1 + {k}_{x} ) {C}_{x}^{2} {x}^{2} - ( 1 + {k}_{y} ) {C}_{y}^{2} {y}^{2}}} + {\sum }_{i = 1}^{16} {α}_{i} {x}_{i} + {\sum }_{i = 1}^{16} {β}_{i} {y}_{i} + {\sum }_{i = 1}^{N} {A}_{i} {Z}_{i} ( ρ , φ )$$

Wherein,

$${C}_{x} = \frac{1}{Rx} , {C}_{y} = \frac{1}{Ry} ,$$

wherein z is a sag of the optical surface; Rₓ and R_{y} are radius of curvature values in the x and y directions respectively; kₓ and k_{y} are conic coefficients; αᵢ, βᵢ are polynomial coefficients; Aᵢ is a polynomial coefficient, ρ is a radial coordinate, φ is an angular coordinate, and N is a number of terms.

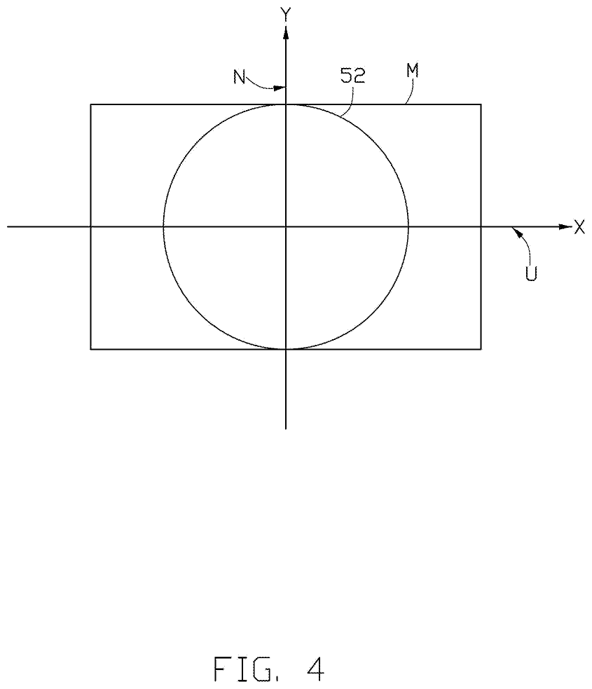

Referring to FIGS. 3 and 4, in this embodiment, the image surface M is substantially rectangular. The X-axis passes through a center of the rectangular image surface M, and is parallel to a center axis of a long side of the rectangular image surface M. The Y-axis direction passes through the center of the rectangular image surface M, and is parallel to a center axis of the short side of the rectangular image surface M. The X-axis and the optical axis O define a first plane N, and the Y-axis and the optical axis O define a second plane U. The fifth lens 50 is centrosymmetrical about the first plane N and the second plane U. Thus, an overall image quality is ensured, and the image quality of an area near the optical axis O is better than the image quality of an edge area away from the optical axis O.

Referring to FIGS. 2 and 3, in this embodiment, the first lens 10 has negative refractive power. An object-side surface 11 and an image-side surface 12 of the first lens 10 can be spherical or aspherical. A curvature radius of the object-side surface 11 of the first lens 10 is greater than 1, and a radius of curvature of the image-side surface 12 is less than 10. Material of the first lens 10 is glass or transparent plastic.

The second lens 20 has positive refractive power. An object-side surface 21 and an image-side surface 22 of the second lens 20 can be spherical or aspherical. A curvature radius of the object-side surface 21 is greater than 1 and less than 10, and a curvature radius of the image-side surface 22 is greater than −10 and less than −1. Material of the second lens 20 is glass or transparent plastic.

The third lens 30 has positive refractive power. An object-side surface 31 and an image-side surface 32 of the third lens 30 can be spherical or aspherical. A curvature radius of the object-side surface 31 of the third lens 30 is less than −10, and a radius of curvature of the image-side surface 32 is less than −1. Material of the third lens 30 is glass or transparent plastic.

The fourth lens 40 has positive refractive power. An object-side surface 41 and an image-side surface 42 of the fourth lens 40 can be spherical or aspherical. A curvature radius of the object-side surface 41 of the fourth lens 40 is greater than 1, and a curvature radius of the image-side surface 42 is less than 10. Material of the fourth lens 40 is glass or transparent plastic.

The fifth lens 50 has positive refractive power. An object-side surface 51 and/or image-side surface 52 of the fifth lens 50 can be freeform surfaces. A curvature radius of the object-side surface 51 and the image-side surface 52 of the fifth lens 50 is less than 1000. Material of the fifth lens 50 is glass or transparent plastic.

Referring to FIG. 3, in this embodiment, the object-side surface 11 of the first lens 10 to the image surface M is TTL along the optical axis O, and the effective focal length of the lens module 100 is EFL, which can satisfy the following conditions: TTL/EFL≤2. This helps to facilitate the miniaturization design of the lens module 100, save space inside the terminal device 200, and facilitate a thin-profile development of the terminal device 200.

The following describes the present disclosure in detail through examples and comparative examples.

### Example

Taking a 1/3.1-inch image element 60 lens, the main lens structure diagram and curvature description of a single free curved surface to improve a distortion caused by image deformation. Table 1a lists the characteristics of lens group in detail, and the units of curvature radius and thickness are mm.

TABLE 1a

| | | Types of | curvature | | | Refractive | Dispersion |
|---|---|---|---|---|---|---|---|
| Lens | Lens surface | surface | radius | Thickness | Material | index | coefficient |
| First lens 10 | Object side 11 | Even | 1.91 | 0.47 | First resin | 1.63 | 23.5 |
| | | Asphere | | | (EP6000) | | |
| | Image side 12 | Even | 1.28 | 0.43 | | | |
| | | Asphere | | | | | |
| Second lens20 | Object side 21 | Even | 3.94 | 1.18 | Second | 1.53 | 57.1 |
| | | Asphere | | | resin | | |
| | Image side 22 | Even | −1.11 | 0.47 | (F52R) | | |
| | | Asphere | | | | | |
| Third lens 30 | Object side 31 | Even | −1.05 | 1.02 | Second | 1.53 | 57.1 |
| | | Asphere | | | resin | | |
| | Image side 32 | Even | −0.98 | 0.06 | (F52R) | | |
| | | Asphere | | | | | |
| Fourth lens 40 | Object side 41 | Even | 3.6 | 0.63 | First resin | 1.63 | 23.5 |
| | | Asphere | | | (EP6000) | | |
| | Image side 42 | Even | 1.65 | 0.32 | | | |
| | | Asphere | | | | | |
| Fifth lens 50 | Object side 51 | Even | Infinity | 0.45 | Second | 1.53 | 57.1 |
| | | Asphere | | | resin | | |
| | Image side 52 | Freeform | −262 | 0.16 | (F52R) | | |
| | | surface | | | | | |

Table 1b gives parameters of conic coefficients k and polynomial coefficients a1, a2, a3, a4, a5, a6, a7, a8, a9, a10, a11, a12, a13, a14, a15, a16 that can be used on each lens surface in this embodiment.

TABLE 1b

| | Object | Image | Object | Image | Object | Image | Object | Image | Object | Image |
|---|---|---|---|---|---|---|---|---|---|---|
| P | side 11 | side 12 | side 21 | side 22 | side 31 | side 32 | side 41 | side 42 | side 51 | side 52 |
| K | −2.635 | 1.117 | −1.942 | −0.674 | −0.455 | −0.965 | −81.19 | −1.017 | 0 | 2508 |
| a1 | 0 | 0 | 0 | 0 | 0 | 0 | 0 | 0 | 0 | 0 |
| a2 | 0 | 0 | 0 | 0 | 0 | 0 | 0 | 0 | 0 | 945.92 |
| a3 | 0 | 0 | 0 | 0 | 0 | 0 | 0 | 0 | 0 | 0 |
| a4 | 0.108 | 0.132 | 0.044 | 0.126 | 0.467 | 0.058 | −0.06 | −0.148 | 0 | 2836 |
| a5 | 0 | 0 | 0 | 0 | 0 | 0 | 0 | 0 | 0 | 0 |
| a6 | −0.03 | −0.134 | −0.024 | 0.051 | −0.216 | −0.0075 | −0.138 | 0.034 | 0 | 0 |
| a7 | 0 | 0 | 0 | 0 | 0 | 0 | 0 | 0 | 0 | 0 |
| a8 | −0.022 | −0.195 | −0.088 | −0.094 | −0.088 | −0.018 | 0.032 | −0.0059 | 0 | 1.617 |
| a9 | 0 | 0 | 0 | 0 | 0 | 0 | 0 | 0 | 0 | 0 |
| a10 | 3.92E−03 | 0.237 | 0.773 | 5.47E−03 | −0.0138 | 0.0133 | 6.14E−03 | 4.97E−04 | 0 | 0 |
| a11 | 0 | 0 | 0 | 0 | 0 | 0 | 0 | 0 | 0 | 0 |
| a12 | 0 | 0 | −1.02 | 0.027 | −1.74E−03 | −1.90E−03 | −2.19E−04 | −7.70E−06 | 0 | 0 |
| a13 | 0 | 0 | 0 | 0 | 0 | 0 | 0 | 0 | 0 | 0 |
| a14 | 0 | 0 | 0 | 0 | 1.30E−03 | −1.70E−04 | −1.64E−04 | 1.39E−07 | 0 | 0 |
| a15 | 0 | 0 | 0 | 0 | 0 | 0 | 0 | 0 | 0 | 0 |
| a16 | 0 | 0 | 0 | 0 | 2.08E−04 | 2.58E−05 | −4.60E−05 | −4.45E−08 | 0 | 0 |

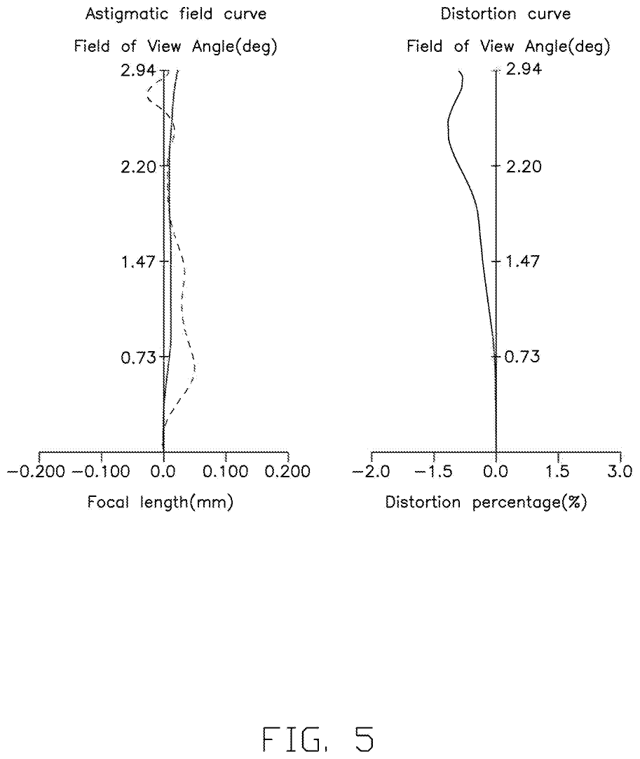

FIG. 5 shows an astigmatic field curve and distortion curve of the lens module 100 in this embodiment, indicating the magnitude of distortion corresponding to different field angles, in this embodiment, the distortion of the wide-angle lens is 1.5%.

### Comparative Example

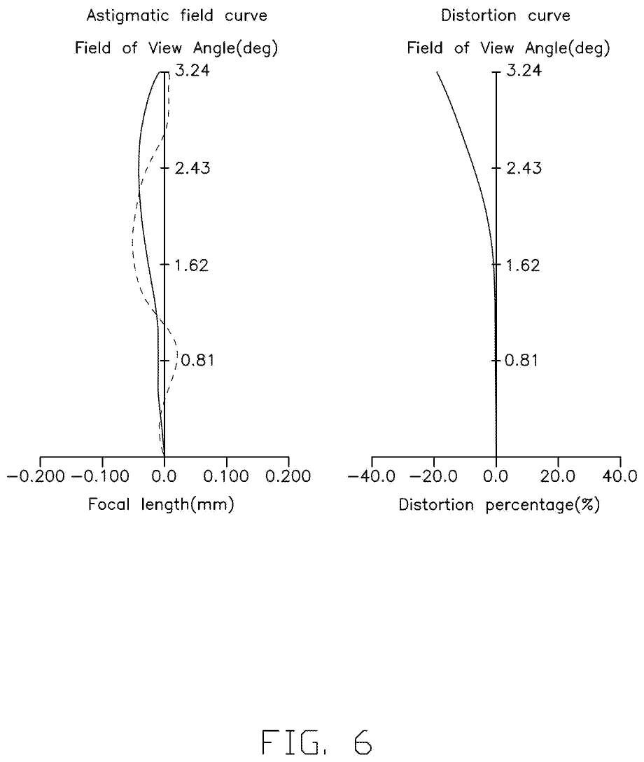

A difference from the embodiment is that the image-side surface 52 of the fifth lens 50 in the comparative example is an even aspherical surface. FIG. 6 shows the astigmatic field curve and distortion curve of the lens module in this comparative example, indicating the magnitude of distortion corresponding to different field angles. It can be found that the distortion of the wide-angle lens in the comparative example is 12.6%.

The embodiments shown and described above are only examples. Many details are often found in the art such as the other features of the lens module 100. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A lens module having an optical axis, the lens module comprising:
a plurality of lenses arranged in sequence from an object side to an image side along the optical axis,
wherein at least one of the plurality of lenses is a freeform lens, the freeform lens comprises an object-side surface facing the object side and an image-side surface facing the image side, at least one of the object-side surface and the image-side surface of the freeform lens is a freeform surface, the lens module further comprises an image surface, an X-axis and a Y-axis are defined as two axes perpendicular to each other and parallel to the image surface, and
the freeform surface is described by an equation:
$$Z = \frac{{C}_{x} {x}^{2} + {C}_{y} {y}^{2}}{\sqrt{1 - ( 1 + {k}_{x} ) {C}_{x}^{2} {x}^{2} - ( 1 + {k}_{y} ) {C}_{y}^{2} {y}^{2}}} + {\sum }_{i = 1}^{16} {α}_{i} {x}_{i} + {\sum }_{i = 1}^{16} {β}_{i} {y}_{i} + {\sum }_{i = 1}^{N} {A}_{i} {Z}_{i} ( ρ , φ ) ;$$
$$where , {C}_{x} = \frac{1}{Rx} , {C}_{y} = \frac{1}{Ry} ,$$
z is a sag of the freeform surface, Rₓ is a radius of curvature along X-aixs, and R_{y} is a radius of curvature along Y-axis, kₓ and k_{y} are conic coefficients, αᵢ, βᵢ are polynomial coefficients, Aᵢ is a polynomial coefficient, ρ is a radial coordinate, φ is an angular coordinate, and N is a number of summation terms.

2. The lens module of claim 1, wherein the freeform lens is symmetrical with respect to a first plane, and the freeform lens is further symmetrical with respect to a second plane, the first plane is defined by the X-axis and the optical axis, and the second plane is defined by the Y-axis and the optical axis.

3. The lens module of claim 1, wherein each of the X-axis and the Y-axis extends through a center of the image surface and parallel to each of a long side and a short side of the image surface.

4. The lens module of claim 1, wherein a quantity E of the plurality of lenses is greater than or equal to 3, the plurality of lenses comprises a first lens to an E^{th} lens arranged in sequence from the object side to the image side, an object-side surface and an image-side surface of each of the first lens to the (E−1)^{th} lenses are all aspherical or spherical, and the E^{th} lens is the freeform lens.

5. The lens module of claim 1, wherein the plurality of lenses comprises a first lens, a second lens, a third lens, a fourth lens, and a fifth lenses arranged in sequence from the object side to the image side.

6. The lens module of claim 5, wherein the first lens has a negative refractive power, the second lens has a positive refractive power, the third lens has a positive refractive power, the fourth lens has a negative refractive power, and the fifth lens has a positive or negative refractive power.

7. The lens module of claim 6, wherein a radius of curvature of an object-side surface of the first lens is greater than 1, and a radius of curvature of an image-side surface of the first lens is less than 10,
a radius of curvature of an object-side surface of the second lens is greater than 1 and less than 10, and a radius of curvature of an image-side surface of the second lens is greater than −10 and less than −1,
a radius of curvature of an object-side surface of the third lens is less than −10, and a radius of curvature of an image-side surface of the third lens is less than −1,
a radius of curvature of an object-side surface of the fourth lens is greater than 1, and a radius of curvature of an image-side surface of the fourth lens is less than 10, and
a radius of curvature of an object-side surface or an image-side surface of the fifth lens is less than 1000.

8. The lens module of claim 6, wherein the first lens, the second lens, the third lens, the third lens, and the fifth lens are made of transparent plastic or glass.

9. The lens module of claim 6, wherein a distance from an object-side surface of the first lens to the image surface on the optical axis is TTL, an effective focal length of the lens module is EFL, and TTL/EFL≤2.

10. A terminal device comprising:
a lens module having an optical axis, the lens module further comprising a plurality of lenses arranged in sequence from an object side to an image side along the optical axis,
wherein at least one of the plurality of lenses is a freeform lens, the freeform lens comprises an object-side surface facing the object side and an image-side surface facing the image side, at least one of the object-side surface and the image-side surface of the freeform lens is a freeform surface, the lens module further comprises an image surface, an X-axis and a Y-axis are defined as two axes perpendicular to each other and parallel to the image surface, and
the freeform surface is described by an equation:
$$Z = \frac{{C}_{x} {x}^{2} + {C}_{y} {y}^{2}}{\sqrt{1 - ( 1 + {k}_{x} ) {C}_{x}^{2} {x}^{2} - ( 1 + {k}_{y} ) {C}_{y}^{2} {y}^{2}}} + {\sum }_{i = 1}^{16} {α}_{i} {x}_{i} + {\sum }_{i = 1}^{16} {β}_{i} {y}_{i} + {\sum }_{i = 1}^{N} {A}_{i} {Z}_{i} ( ρ , φ ) ;$$
$$where , {C}_{x} = \frac{1}{Rx} , {C}_{y} = \frac{1}{Ry} ,$$
z is a sag of the freeform surface, Rₓ is a radius of curvature along X-aixs, and R_{y} is a radius of curvature along Y-axis, kₓ and k_{y} are conic coefficients, αᵢ, βᵢ are polynomial coefficients, Aᵢ is a polynomial coefficient, ρ is a radial coordinate, φ is an angular coordinate, and N is a number of summation terms.

11. The terminal device of claim 10, wherein the freeform lens is symmetrical with respect to a first plane, and the freeform lens is further symmetrical with respect to a second plane, the first plane is defined by the X-axis and the optical axis, and the second plane is defined by the Y-axis and the optical axis.

12. The terminal device of claim 10, wherein each of the X-axis and the Y-axis extends through a center of the image surface and parallel to each of a long side and a short side of the image surface.

13. The terminal device of claim 10, wherein a quantity E of the plurality of lenses is greater than or equal to 3, the plurality of lenses comprises a first lens to an E^{th} lens arranged in sequence from the object side to the image side, an object-side surface and an image-side surface of each of the first lens to the (E−1)^{th} lenses are all aspherical or spherical, and the E^{th} lens is the freeform lens.

14. The terminal device of claim 10, wherein the plurality of lenses comprises a first lens, a second lens, a third lens, a fourth lens, and a fifth lenses arranged in sequence from the object side to the image side.

15. The terminal device of claim 14, wherein the first lens has a negative refractive power, the second lens has a positive refractive power, the third lens has a positive refractive power, the fourth lens has a negative refractive power, and the fifth lens has a positive or negative refractive power.

16. The terminal device of claim 15, wherein a radius of curvature of an object-side surface of the first lens is greater than 1, and a radius of curvature of an image-side surface of the first lens is less than 10,
a radius of curvature of an object-side surface of the second lens is greater than 1 and less than 10, and a radius of curvature of an image-side surface of the second lens is greater than −10 and less than −1,
a radius of curvature of an object-side surface of the third lens is less than −10, and a radius of curvature of an image-side surface of the third lens is less than −1,
a radius of curvature of an object-side surface of the fourth lens is greater than 1, and a radius of curvature of an image-side surface of the fourth lens is less than 10, and
a radius of curvature of an object-side surface or an image-side surface of the fifth lens is less than 1000.

17. The terminal device of claim 15, wherein the first lens, the second lens, the third lens, the third lens, and the fifth lens are made of transparent plastic or glass.

18. The terminal device of claim 15, wherein a distance from an object-side surface of the first lens to the image surface on the optical axis is TTL, an effective focal length of the lens module is EFL, and TTL/EFL≤2.
